(19) United States
(12) Patent Application Publication
(10) Pub. No.: US 2023/0213066 A1
(43) Pub. Date: Jul. 6, 2023

(54) MODULAR ECCENTRIC LOCKING SYSTEM AND ATTACHMENT METHOD FOR CIRCULAR BORES

(71) Applicant: Dodge Industrial, Inc, Oxford, CT (US)

(72) Inventors: Thomas Kuckhoff, Greenville, SC (US); Christopher Kent Aldridge, Marion, NC (US); Jerry Holsombach, Marion, NC (US); Randy Rampey, Old Fort, NC (US)

(73) Assignee: Dodge Industrial, Inc, Oxford, CT (US)

(21) Appl. No.: 17/570,295

(22) Filed: Jan. 6, 2022

(51) Int. Cl. F16C 35/04; F16C 33/76

(52) U.S. Cl. CPC F16C 35/045; F16C 33/767; F16C 2208/82

(57) ABSTRACT

A cover assembly includes a ring. The ring has a bore with an eccentric inner geometry. The cover assembly includes a cap. The cap has an eccentric outer geometry. The cap is configured to fit within the bore of the ring. In a concentric position, the eccentric outer geometry of the cap and the eccentric inner geometry of the ring are configured to be offset. In an eccentric position, the eccentric outer geometry of the cap is configured to force the eccentric inner geometry of the ring outward.

### FIELD

This disclosure relates generally to equipment having a rotational shaft. More particularly, this disclosure relates to a cover for covering a rotational shaft.

### BACKGROUND

Machinery often has exposed rotating shafts. Generally, protruding shafts have been guarded through mechanical fasteners or mechanical interference fits. However, these types of guards can be time consuming to install, include a multitude of assembly pieces, and can require a large amount of force to install, thereby leading to improper installation or damage to the guards during installation. This can lead to potential injury to users exposed to the harmful rotating shaft.

### SUMMARY

In some embodiments, a cover assembly includes a ring. In some embodiments, the ring has a bore with an eccentric inner geometry. In some embodiments, the cover assembly includes a cap. In some embodiments, the cap has an eccentric outer geometry. In some embodiments, the cap is configured to fit within the bore of the ring. In some embodiments, in a concentric position, the eccentric outer geometry of the cap and the eccentric inner geometry of the ring are configured to be offset. In some embodiments, in an eccentric position, the eccentric outer geometry of the cap is configured to force the eccentric inner geometry of the ring outward.

In some embodiments, the cover assembly includes a plurality of fasteners configured to secure the cap to the ring.

In some embodiments, the cap includes a plurality of channels, the plurality of fasteners configured to extend through the plurality of channels and be secured to the ring.

In some embodiments, the plurality of channels are configured to enable rotation of the cap relative to the ring of 90°. In some embodiments, the rotation of the cap relative to the ring can be in a first direction or a second direction that is opposite the first direction. In some embodiments, the rotation of the cap relative to the ring can be from 60° to 120° or the like.

In some embodiments, in a secured configuration, the plurality of fasteners are configured to prevent rotation of the cap relative to the ring.

In some embodiments, the cap is rotated clockwise to move from the concentric position to the eccentric position.

In some embodiments, at least one of the ring or the cap include a non-metallic material. In some embodiments, the non-metallic material includes a short fiber thermoset. In some embodiments, the short fiber thermoset is a high durometer rubber.

In some embodiments, at least one of the ring or the cap include a metallic material.

In some embodiments, the eccentric inner geometry of the ring comprises 2 to 5 lobes.

In some embodiments, the ring includes a sawcut.

In some embodiments, the cap includes a tab, wherein the tab is configured to cover the sawcut when the cover assembly is in the eccentric position.

In some embodiments, an assembly includes a bearing housing; a bearing disposed within the bearing housing; and a cover assembly configured to be secured to the bearing housing. In some embodiments, the cover assembly includes a ring. In some embodiments, the ring has a bore with an eccentric inner geometry. In some embodiments, the cover assembly includes a cap. In some embodiments, the cap has an eccentric outer geometry. In some embodiments, the cap is configured to fit within the bore of the ring. In some embodiments, in a concentric position, the eccentric outer geometry of the cap and the eccentric inner geometry of the ring are configured to be offset. In some embodiments, in an eccentric position, the eccentric outer geometry of the cap is configured to force the eccentric inner geometry of the ring outward.

In some embodiments, the cover assembly includes a plurality of fasteners configured to secure the cap to the ring.

In some embodiments, the cap includes a plurality of channels, the plurality of fasteners configured to extend through the plurality of channels and be secured to the ring.

In some embodiments, the plurality of channels are configured to enable rotation of the cap relative to the ring of 90°. In some embodiments, the rotation of the cap relative to the ring can be in a first direction or a second direction that is opposite the first direction. In some embodiments, the rotation of the cap relative to the ring can be from 60° to 120° or the like.

In some embodiments, in a secured configuration, the plurality of fasteners are configured to prevent rotation of the cap relative to the ring.

In some embodiments, the cap is rotated clockwise to move from the concentric position to the eccentric position.

In some embodiments, at least one of the ring or the cap include a non-metallic material. In some embodiments, the non-metallic material includes a short fiber thermoset. In some embodiments, the short fiber thermoset is a high durometer rubber.

In some embodiments, at least one of the ring or the cap include a metallic material.

In some embodiments, the eccentric inner geometry of the ring comprises a plurality of lobes.

In some embodiments, the ring includes a sawcut.

In some embodiments, the cap includes a tab, wherein the tab is configured to cover the sawcut when the cover assembly is in the eccentric position.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a bearing assembly, according to some embodiments.

FIG. 2 shows a sectional view of the bearing assembly of FIG. 1, according to some embodiments.

FIG. 3 shows a sectional view of the bearing assembly of FIG. 1, according to some embodiments.

FIG. 4 shows an exploded perspective view of the cover assembly of FIG. 1, according to some embodiments.

FIG. 5 shows a side view of a ring of the cover assembly of FIG. 1, according to some embodiments.

FIG. 6 shows a side view of a cap of the cover assembly of FIG. 1, according to some embodiments.

FIG. 7 shows a side view of the cover assembly of FIG. 1 in a concentric position, according to some embodiments.

FIG. 8 shows a side view of the cover assembly of FIG. 1 in an eccentric position, according to some embodiments.

Like reference numbers represent the same or similar parts throughout.

### DETAILED DESCRIPTION

Embodiments of the present disclosure are directed to a cover assembly for a circular bore such as in a bearing assembly. In some embodiments, the cover assembly can be installed in a short period of time and with limited tools. In some embodiments, the cover assembly can be installed within the circular bore without additional attachment methods.

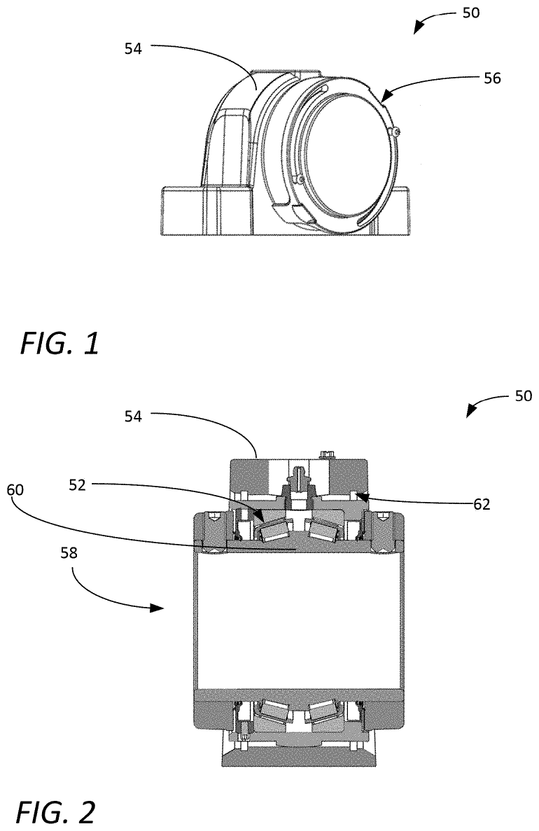

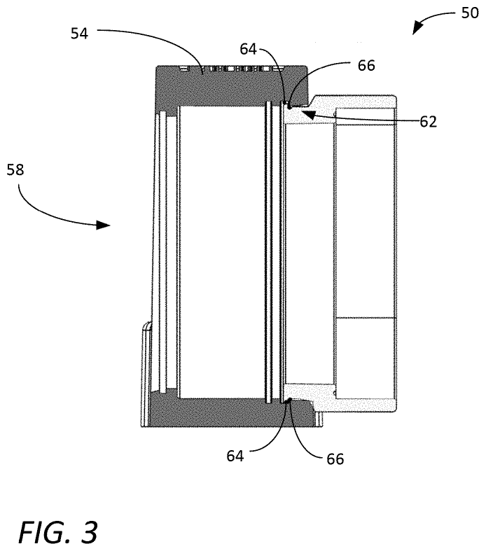

FIGS. 1-3 show a bearing assembly 50, according to some embodiments. The bearing assembly 50 can include a bearing 52, a bearing housing 54 for housing the bearing, and a cover assembly 56.

In some embodiments, the bearing assembly 50 can include a pillow block bearing as shown in FIG. 1, or a flanged or take-up bearing assembly configuration. The bearing assembly 50 is generally configured for utilization with a round or circular shaft. In some embodiments, the shaft may be a turned, ground, polished (TGP) shaft or the like. In some embodiments, the shaft is not turned, ground, and polished. In some embodiments, the cover assembly 56 can guard the shaft to protect operators.

In some embodiments, the bearing 52 can include roller bearings. In some embodiments, the bearing 52 can alternatively include deep groove ball bearings, or the like. The bearing 52 can have an inner ring 60 concentrically disposed with an outer ring with rotational elements therebetween adapted for allowing rotational movement of the inner ring 60 relative to the outer ring. The inner ring 60 receives a shaft when installed for use.

In some embodiments, the bearing 52 can have an operable speed range of from 3,000 to 15,000 revolutions per minute (RPM). In some embodiments, the bearing 52 can have an operable speed range of 3,000 to 14,000 RPM. In some embodiments, the bearing 52 can have an operable speed range of 3,000 to 13,000 RPM. In some embodiments, the bearing 52 can have an operable speed range of 3,000 to 12,000 RPM. In some embodiments, the bearing 52 can have an operable speed range of 3,000 to 11,000 RPM. In some embodiments, the bearing 52 can have an operable speed range of 3,000 to 10,000 RPM. In some embodiments, the bearing 52 can have an operable speed range of 3,000 to 9,000 RPM. In some embodiments, the bearing 52 can have an operable speed range of 3,000 to 8,000 RPM. In some embodiments, the bearing 52 can have an operable speed range of 3,000 to 7,000 RPM. In some embodiments, the bearing 52 can have an operable speed range of 3,000 to 6,000 RPM. In some embodiments, the bearing 52 can have an operable speed range of 3,000 to 5,000 RPM. In some embodiments, the bearing 52 can have an operable speed range of 3,000 to 4,000 RPM.

In some embodiments, the bearing 52 can have an operable speed range of 4,000 RPM to 15,000 RPM. In some embodiments, the bearing 52 can have an operable speed range of 5,000 RPM to 15,000 RPM. In some embodiments, the bearing 52 can have an operable speed range of 6,000 to 15,000 RPM. In some embodiments, the bearing 52 can have an operable speed range of 7,000 RPM to 15,000 RPM. In some embodiments, the bearing 52 can have an operable speed range of 8,000 RPM to 15,000 RPM. In some embodiments, the bearing 52 can have an operable speed range of 9,000 RPM to 15,000 RPM. In some embodiments, the bearing 52 can have an operable speed range of 10,000 RPM to 15,000 RPM. In some embodiments, the bearing 52 can have an operable speed range of 11,000 RPM to 15,000 RPM. In some embodiments, the bearing 52 can have an operable speed range of 12,000 RPM to 15,000 RPM. In some embodiments, the bearing 52 can have an operable speed range of 13,000 RPM to 15,000 RPM. In some embodiments, the bearing 52 can have an operable speed range of 14,000 to 15,000 RPM. It is to be appreciated that these speed ranges are examples and the actual speed of the bearing 52 can vary beyond the stated ranges.

The bearing housing 54 can be solid or split. The bearing assembly 50 can be sealed or be provided with re-lubrication features. The bearing assembly 50 can be provided as a unit with the bearing 52 factory installed in the bearing housing 54. The bearing 52 can be supplied separately to be assembled by an end-user with the bearing housing 54, as needed. The materials used in connection with the bearing assembly 50 widely vary depending upon the application, and may include polymers, steels, iron, other cast materials, combinations thereof, or the like.

The bearing housing 54 has a bore 58. The bore 58 can be sized and shaped to accommodate the bearing 52. When the bearing assembly 50 is assembled and the bearing 52 is constrained in the bore 58, the bearing 52 can be maintained in position within the bearing assembly 50. The bearing housing 54 can have a hole for accepting a lubrication fitting that extends through the bore 58 to allow the fitting to be placed in register with lubrication ports formed on the bearing 52.

In some embodiments, the cover assembly 56 can reduce contaminants (e.g., dirt, water, chemicals, etc.) from entering the bearing housing 54. The cover assembly 56 can engage with the bore 58 when the cover assembly 56 is in an installed state. In some embodiments, the cover assembly 56 can engage with the bore 58 without additional mechanical fasteners. In some embodiments, the cover assembly 56 can be simple to install with minimal hand tools such as, but not limited to, a screwdriver or the like. In some embodiments, the cover assembly 56 can have improved mechanical rigidity to withstand an impact force imposed on the cover assembly 56 to resist damage and to remain fastened in the bore 58. In some embodiments, the cover assembly 56 can be installed within a circular bore (e.g., the bore 58) without modification of the bore 58. In some embodiments, the bore 58 can be modified to include a groove 62 for additional retention strength. The groove 62 can receive the cover assembly 56 and serve as an additional engagement with the cover assembly 56 to hold the cover assembly 56 in the installed state and prevent the cover assembly 56 from unintentionally being uninstalled from the bearing assembly 50.

In some embodiments, the cover assembly 56 can be installed to the bearing assembly 50 before the bearing 52 is installed in the bearing housing 54. In some embodiments, the cover assembly 56 can be installed to the bearing assembly 50 after the bearing 52 is installed in the bearing housing 54.

In some embodiments, the groove 62 of the bearing housing 54 can include a radial seal 64 located in the groove 62 of the bearing housing 54. The radial seal 64 can serve as an additional engagement with the cover assembly 56 to hold the cover assembly 56 in the installed state. The radial seal 64 can also further seal the bearing housing 54 and further reduce contaminants (e.g., dirt, water, chemicals, etc.) from entering the bearing housing 54. In some embodiments, a radial seal 66 can be disposed around an outer surface of the cover assembly 56 in addition to the radial seal 64. In some embodiments, the radial seal 64 can be included without the radial seal 66. In some embodiments, the radial seal 66 can be included without the radial seal 64. In some embodiments, the radial seal 64 and the radial seal 66 can both be included.

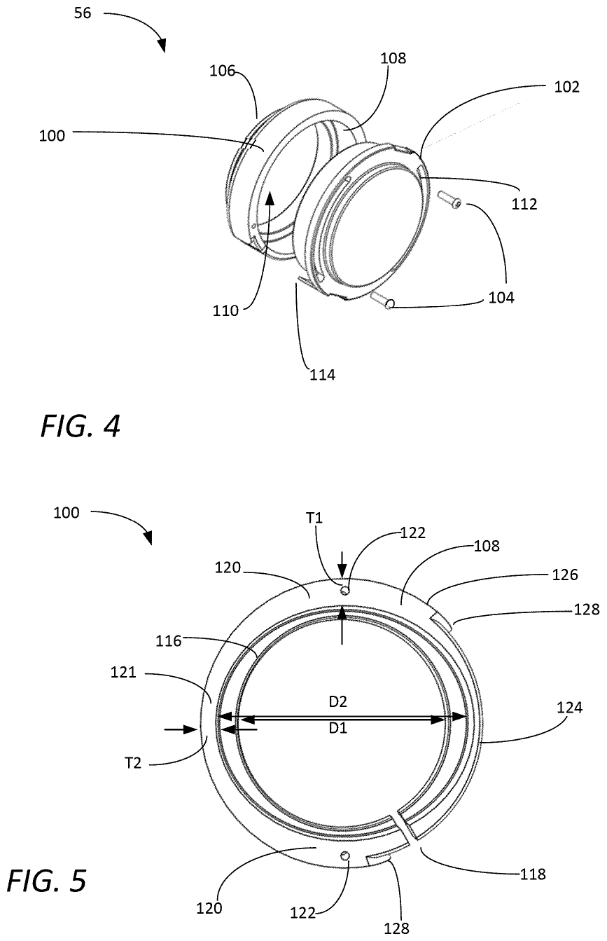

FIG. 4 shows an exploded perspective view of the cover assembly 56, according to some embodiments.

In some embodiments, the cover assembly 56 includes a ring 100, a cap 102, and a plurality of fasteners 104.

In some embodiments, the ring 100 includes a first ring 106 and a second ring 108, integrally formed. The first ring 106 is configured to be inserted into the bore 58 (FIG. 1). The second ring 108 is configured to receive the cap 102. In some embodiments, the cap 102 is configured to fit into a bore 110 of the second ring 108. In some embodiments, when the first ring 106 is installed within the bore 58 and the cap 102 is inserted into the bore 110, the cap 102 can be rotated relative to the ring 100 to secure the cover assembly 56 within the bore 58. In some embodiments, the cap 102 may rotate while the ring 100 remains stationary due to frictional engagement between the ring 100 and the bore 58. In some embodiments, before rotating the cap 102, the cover assembly 56 can be in a concentric position. In some embodiments, after rotating the cap 102, the cover assembly 56 can be in an eccentric position.

In some embodiments, the cap 102 can be rotated 90° to secure the cover assembly 56 within the bore 58. In some embodiments, the rotational amount can vary from 90°. For example, in some embodiments, the rotational amount can be from 80° to 100°. In some embodiments, the rotational amount can be less than 80°. For example, in some embodiments, the rotational amount can be 45°. In some embodiments, the rotational amount can be from 40° to 100°. In some embodiments, the rotational amount can be greater than 100°. For example, in some embodiments, the rotational amount can be 180°. It is to be appreciated that these values are examples, and the exact amount of rotation can vary beyond the stated values and ranges.

In some embodiments, the cap 102 can be rotated in a clockwise direction to move from the concentric position to the eccentric position. In some embodiments, the cap 102 can be rotated in a counterclockwise direction to move from the eccentric position to the concentric position. In some embodiments, the directions can be reversed. In some embodiments, the clockwise direction for moving from the concentric position to the eccentric position can be selected so that a user intuitively understands which direction to rotate the cap 102 to secure the cover assembly 56. In some embodiments, the eccentric position can be maintained by tightening the fasteners 104 to prevent counterrotation of the cap 102. In some embodiments, tightening the fasteners 104 can provide additional strength in, for example, high vibration applications.

In some embodiments, the cover assembly 56 can be partially assembled during the manufacturing process. For example, in some embodiments, the cap 102 can be inserted into the ring 100 and the fasteners 104 partially tightened during the manufacturing process. As a result, the cover assembly 56 can be provided to the operator as a single unit. In some embodiments, providing the cover assembly 56 as a single unit can simplify a number of steps the operator takes to install the cover assembly 56. In some embodiments, providing the cover assembly 56 as a single unit can also provide an indication to the operator as to which direction the cap 102 is to be rotated to move to the eccentric position. In some embodiments, this may be the result of the cap 102 including a plurality of channels 112 through which the fasteners 104 are inserted. The channels 112 can make it such that the cap 102 is rotatable in a first direction (e.g., clockwise), but not in a second direction (e.g., counterclockwise) since the fasteners 104 abut ends of the channels 112.

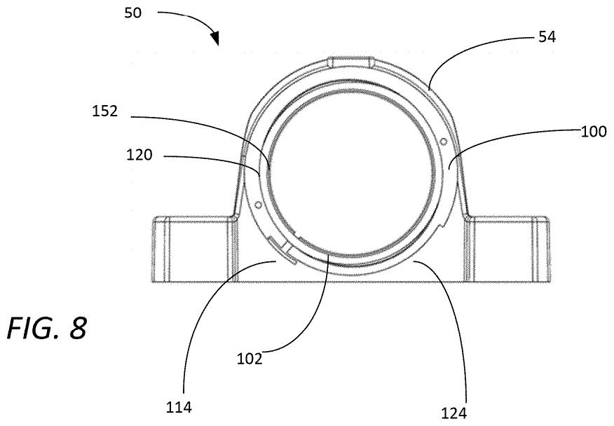

In some embodiments, the cap 102 includes a tab 114. The tab 114 can be configured to cover a sawcut in the ring 100 when the cover assembly 56 is installed and in a concentric position to prevent contaminants from entering via the sawcut in the ring 100. This is shown in the view illustrated in FIG. 8.

FIG. 5 shows a side view of the ring 100, according to some embodiments.

In some embodiments, the ring 100 includes a non-metallic material. In some embodiments, the non-metallic material includes a short fiber thermoset, silicone, ethylene propylene diene monomer (EPDM), other similar materials, or combinations thereof. In some embodiments, the short fiber thermoset is a high durometer rubber. In some embodiments, the ring 100 includes a metallic material. In some embodiments, the metallic material includes aluminum or aluminum alloys, copper and zinc alloys, steel, low or medium carbon steel, stainless steel, other alloys, or the like.

The ring 100 includes the first ring 106 and the second ring 108. The first ring 106 is configured to engage with the bore 58. The first ring 106 and the second ring 108 can be defined by a shoulder 116. In some embodiments, shoulder 116 can have a diameter D1. The diameter D1 can be smaller than a diameter D2 of the second ring 108. The shoulder 116 can provide a stop for aligning the cap 102 axially with the ring 100. In some embodiments, the shoulder 116 can protrude from an inner wall of the ring 100 a distance sufficient to prevent the cap 102 from being inserted into the ring 100 past the shoulder 116.

In some embodiments, the ring 100 includes a sawcut 118 that extends along an entire length of the ring 100. The sawcut 118 can, for example, provide flexibility to the ring 100. As a result, manufacturing tolerances between the ring 100 and the bore 58 can be relaxed as the ring 100 has some flexibility based on the gap in the ring 100. In some embodiments, the sawcut 118 also provides flexibility for the ring 100 to expand when a force is applied from the cap 102 to force the ring 100 to expand and securely engage with the bore 58.

In some embodiments, the second ring 108 includes a plurality of lobes 120. That is, in some embodiments, a geometry of the inner surface of the second ring 108 is not circular. The lobes 120 have a thickness T1 that is greater than a thickness T2 of portions 121 of the second ring 108. In some embodiments, the lobes 120 include two lobes. In some embodiments, the lobes 120 can include more than two lobes. In some embodiments, the lobes 120 can include five lobes. In some embodiments, the lobes 120 can include from two to five lobes. In some embodiments, the lobes 120 can include 4 lobes. In some embodiments, the lobes 120 can include 3 lobes. In some embodiments, manufacturing may be simpler with fewer of the lobes 120.

In some embodiments, the ring 100 includes a plurality of apertures 122. The apertures 122 are configured to receive the fasteners 104 to secure the cap 102 to the ring 100.

In some embodiments, ring 100 includes a step 124 on an outer surface 126 of the ring 100. The step 124 can include an area along the circumference which has a reduced thickness relative to the remaining portion of the outer surface 126. In some embodiments, the step 124 can provide a plurality of shoulders 128. The plurality of shoulders 128 can be provided to serve as rotational stops for a corresponding finger on the cap 102. The shoulders 128 and the step 124 can also provide a visual indication for aligning the cap 102 and the ring 100 when connecting the two components to form the assembly 56.

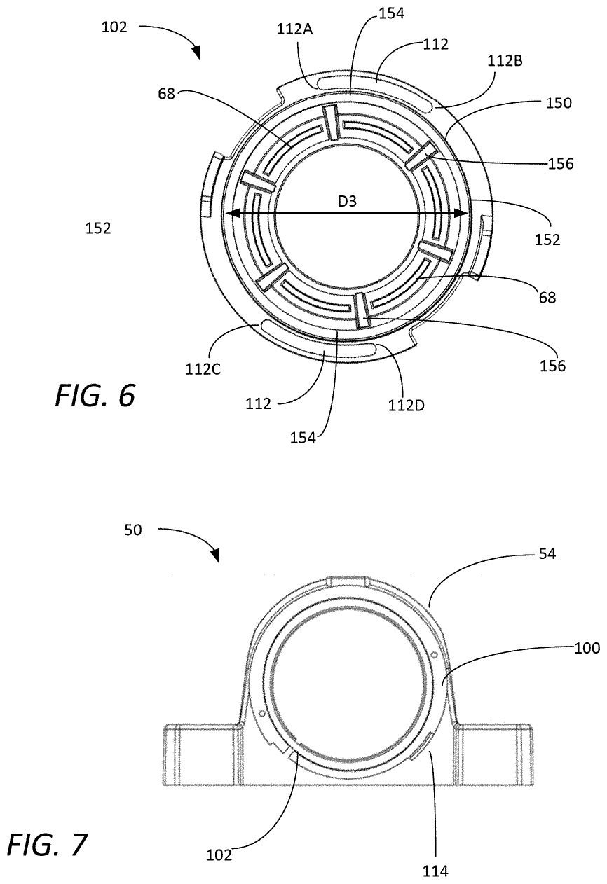

FIG. 6 shows a side view of the cap 102, according to some embodiments.

In some embodiments, the cap 102 can be made of the same material as the ring 100. In some embodiments, the cap 102 can be made of a different material than the ring 100. In some embodiments, the cap 102 includes a non-metallic material. In some embodiments, the non-metallic material includes a short fiber thermoset, silicone, ethylene propylene diene monomer (EPDM), other similar materials, or combinations thereof. In some embodiments, the short fiber thermoset is a high durometer rubber. In some embodiments, the cap 102 includes a metallic material. In some embodiments, the metallic material includes aluminum or aluminum alloys, copper and zinc alloys, steel, low or medium carbon steel, stainless steel, other alloys, or the like.

The cap 102 includes a ring 150. The ring 150 is configured to have an outer diameter D3 that is smaller than the diameter D2 of the ring 100. As a result, the ring 150 is insertable into the ring 100. In some embodiments, the ring 150 is insertable into the second ring 108 of the ring 100 and can abut the shoulder 116 of the ring 100.

In some embodiments, the ring 150 of the cap 102 has an outer geometry that is not circular. That is, in some embodiments, the outer surface of the ring 150 includes a plurality of lobes 152. In some embodiments, the lobes 152 includes two of the lobes 152. In some embodiments, the lobes 152 can include more than two lobes. In some embodiments, manufacturing may be simpler with fewer of the lobes 152. The lobes 152 can engage with the lobes 120 of the ring 100 to secure the cover assembly 56 in the bore 58. In some embodiments, the lobes 152 have a thickness that is greater than a thickness of portions 154 of the ring 150.

In some embodiments, the cap 102 includes the channels 112. The channels 112 are configured to provide a guide for the fasteners 104. The channels 112 include a plurality of ends 112A-112D. The plurality of ends 112A-112D serve as stopping points for the rotation of the cap 102 relative to the ring 100. As such, a size of the channels 112 is selected to correspond to a desired amount of rotation to move the cap 102 from the concentric position to the eccentric position.

In some embodiments, an interior portion of the cap 102 can include a plurality of ribs 156. The plurality of ribs 156 can increase a strength of the cap 102 (e.g., for increasing a resistance to impacts). A number of the ribs 156 can vary. In some embodiments, the number of the ribs 156 can be selected as a tradeoff between manufacturing complexity, costs, and strength provided.

In some embodiments, the cap 102 includes a plurality of slots 68. In some embodiments, the plurality of slots 68 can be located between the ribs 156 of the cap 102. In some embodiments, the number of slots 68 corresponds to the number of ribs 156 on the cap 102. In some embodiments, the plurality of slots 68 can be areas in which the cap 102 has a thinner material than the material used to construct areas of the cap 102 around the slots 68. This thinner material can be removed by a user to provide viewing access to the bearing housing 54 for maintenance or other reasons. In some embodiments, the plurality of slots 68 can be knockout slots.

FIG. 7 shows a side view of the cover assembly 56 in the concentric position, according to some embodiments.

In some embodiments, in the concentric position, the cap 102 is installed within the ring 100 so that the second ring 108 surrounds the ring 150 of the cap 102 about a circumference of the ring 150. In some embodiments, the concentric position can be a position in which the cover assembly 56 is in an unsecured state.

In the concentric position, the lobes 120 of the ring 100 are offset from the lobes 152 of the cap 102. That is, the lobes 120 of the ring 100 are aligned with the thinner portions of the ring 150 and the lobes 152 are aligned with thinner portions of the second ring 108.

FIG. 8 shows a side view of the cover assembly 56 in the eccentric position, according to some embodiments. The eccentric position includes rotating the cap 102 relative to the ring 100 from the concentric position.

In some embodiments, the cap 102 can be rotated 90° to secure the cover assembly 56 within the bore 58. In some embodiments, the rotational amount can vary from 90°. For example, in some embodiments, the rotational amount can be from 80° to 100°. In some embodiments, the rotational amount can be less than 80°. For example, in some embodiments, the rotational amount can be 45°. In some embodiments, the rotational amount can be from 40° to 100°. In some embodiments, the rotational amount can be greater than 100°. For example, in some embodiments, the rotational amount can be 180°. It is to be appreciated that these values are examples, and the exact amount of rotation can vary beyond the stated values and ranges.

In some embodiments, the cap 102 can be rotated in a clockwise direction to move from the concentric position to the eccentric position. In some embodiments, the cap 102 can be rotated in a counterclockwise direction to move from the eccentric position to the concentric position. In some embodiments, the directions can be reversed. In some embodiments, the clockwise direction for moving from the concentric position to the eccentric position can be selected so that a user intuitively understands which direction to rotate the cap 102 to secure the cover assembly 56. In some embodiments, the eccentric position can be maintained by tightening the fasteners 104 to prevent counterrotation of the cap 102. In some embodiments, tightening the fasteners 104 can provide additional strength in, for example, high vibration applications.

Once in the eccentric position, fasteners 104 can be tightened to prevent the cover assembly 56 from inadvertently returning to the concentric position.

In some embodiments, in the eccentric position, the cap 102 is installed within the ring 100 so that the second ring 108 surrounds the ring 150 of the cap 102 about a circumference of the ring 150. In some embodiments, the concentric position can be a position in which the cover assembly 56 is in a secured state.

In the concentric position, the lobes 120 of the ring 100 are aligned and abut the lobes 152 of the cap 102. That is, the lobes 120 of the ring 100 apply a force to the lobes 152, forcing the second ring 108, and accordingly, the first ring 106 radially outward. This force holds the cover assembly 56 in the bore 58.

In some embodiments, a method for installing the cover assembly 56 for an assembly including a rotating shaft (e.g., the bearing assembly 50) includes inserting a first ring 106 of the cover assembly 56 into a bore 58 of the bearing assembly 50. Once the cover assembly 56 is inserted into the bearing assembly 50, the method includes rotating the cap 102 relative to the ring 100 to move from a concentric position to an eccentric position. In some embodiments, rotating the cap 102 can be in a clockwise direction relative to the ring 100. In some embodiments, rotating the cap 102 can be in a counterclockwise direction relative to the ring 100. In some embodiments, an amount of rotation can vary (as discussed in further detail above). In some embodiments, the amount of rotation can be from 60° to 120°, and in some embodiments, can be 90°.

In some embodiments, the method for installing the cover assembly 56 includes tightening at least one fastener 104 until the at least one fastener 104 engages the cap 102 to keep the cap 102 from being able to rotate relative to the ring 100.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A cover assembly, comprising:
a ring,
wherein the ring has a bore with an eccentric inner geometry; and
a cap,
wherein the cap has an eccentric outer geometry,
wherein the cap is configured to fit within the bore of the ring;
wherein in a concentric position, the eccentric outer geometry of the cap and the eccentric inner geometry of the ring are configured to be offset,
wherein in an eccentric position, the eccentric outer geometry of the cap is configured to force the eccentric inner geometry of the ring outward.

2. The cover assembly of claim 1, further comprising a plurality of fasteners configured to secure the cap to the ring.

3. The cover assembly of claim 2, wherein the cap further comprises a plurality of channels, the plurality of fasteners configured to extend through the plurality of channels and be secured to the ring.

4. The cover assembly of claim 3, wherein the plurality of channels are configured to enable rotation of the cap relative to the ring of 60° to 120°.

5. The cover assembly of claim 4, wherein in a secured configuration, the plurality of fasteners are configured to prevent rotation of the cap relative to the ring.

6. The cover assembly of claim 1, wherein the cap is rotated clockwise to move from the concentric position to the eccentric position.

7. The cover assembly of claim 1, wherein at least one of the ring or the cap include a non-metallic material.

8. The cover assembly of claim 7, wherein the non-metallic material includes a short fiber thermoset, wherein the short fiber thermoset is a high durometer rubber.

9. The cover assembly of claim 1, wherein the eccentric inner geometry of the ring comprises 2 to 5 lobes.

10. The cover assembly of claim 1, wherein the ring comprises a sawcut.

11. The cover assembly of claim 10, wherein the cap comprises a tab, wherein the tab is configured to cover the sawcut when the cover assembly is in the eccentric position.

12. An assembly, comprising:
a bearing housing;
a bearing disposed within the bearing housing; and
a cover assembly configured to be secured to the bearing housing, comprising:
a ring,
wherein the ring has a bore with an eccentric inner geometry; and
a cap,
wherein the cap has an eccentric outer geometry,
wherein the cap is configured to fit within the bore of the ring;
wherein in a concentric position, the eccentric outer geometry of the cap and the eccentric inner geometry of the ring are configured to be offset,
wherein in an eccentric position, the eccentric outer geometry of the cap is configured to force the eccentric inner geometry of the ring outward,
wherein in the eccentric position, the cover assembly is secured to the bearing housing.

13. The assembly of claim 12, further comprising a plurality of fasteners configured to secure the cap to the ring.

14. The assembly of claim 13, wherein the cap further comprises a plurality of channels, the plurality of fasteners configured to extend through the plurality of channels and be secured to the ring.

15. The assembly of claim 14, wherein the plurality of channels are configured to enable rotation of the cap relative to the ring of 60° to 120°.

16. The assembly of claim 15, wherein in a secured configuration, the plurality of fasteners are configured to prevent rotation of the cap relative to the ring.

17. The assembly of claim 12, wherein the cap is rotated clockwise to move from the concentric position to the eccentric position.

18. The assembly of claim 12, wherein at least one of the ring or the cap include a non-metallic material, wherein the non-metallic material includes a short fiber thermoset.

19. The assembly of claim 12, wherein the eccentric inner geometry of the ring comprises a plurality of lobes.

20. The assembly of claim 12, further comprising a seal between the ring and the bearing housing.
